(19) United States
(12) Patent Application Publication
(10) Pub. No.: US 2014/0023578 A1
(43) Pub. Date: Jan. 23, 2014

(54) REACTOR SYSTEM AND METHOD OF POLYCRYSTALLINE SILICON PRODUCTION THEREWITH

(71) Applicant: REC Silicon Inc, Moses Lake, WA (US)

(72) Inventor: Robert J. Geertsen, Moses Lake, WA (US)

(73) Assignee: REC Silicon Inc, Moses Lake, WA (US)

(21) Appl. No.: 13/944,722

(22) Filed: Jul. 17, 2013

Related U.S. Application Data
(60) Provisional application No. 61/672,703, filed on Jul. 17, 2012.

(51) Int. Cl. C01B 33/12

(52) U.S. Cl. CPC C01B 33/126
USPC 423/337; 137/1; 422/139

(57) ABSTRACT

A method and system for reduction or mitigation of metal contamination of polycrystalline silicon are disclosed. Metal contamination of granulate polycrystalline silicon, from contact with a metal surface of components of the supporting transportation and auxiliary infrastructure of a fluidized bed reactor unit, is mitigated by use of a protective coating comprising a microcellular elastomeric polyurethane.

### CROSS REFERENCE TO RELATED APPLICATION

This claims the benefit of U.S. Provisional Application No. 61/672,703, filed Jul. 17, 2012, which is incorporated herein in its entirety by reference.

### FIELD

The present invention concerns reduction or mitigation of metal-contamination of polycrystalline silicon. In particular the invention relates to mitigation of metal contamination of granulate polycrystalline silicon from a metal surface of components of the supporting transportation and auxiliary infrastructure.

### BACKGROUND

Silicon of ultra-high purity is used extensively for applications in the electronic industry and the photovoltaic industry. The purity demanded by industry for these applications is extremely high and frequently materials with only trace amounts of contamination measured at the part per billion levels are deemed acceptable. By rigorous control of the purity of the reactants used to manufacture polycrystalline silicon it is possible to produce such high purity polycrystalline silicon but then extreme care must be taken in any handling, packaging or transportation operations to avoid post contamination. At any time the polycrystalline silicon is in contact with a surface there is a risk of contamination of the polycrystalline silicon with that surface material. If the extent of contamination exceeds certain industrial stipulations then the ability to sell the material into these end applications may be restricted or even denied. In this respect minimizing contact metal contamination is a primary concern if performance criteria in the semiconductor industries are to be attained.

A process for manufacturing polycrystalline silicon that is now gaining in commercial acceptance involves the use of a fluidized bed reactor to manufacture granulate polycrystalline silicon by the pyrolysis of a silicon-containing gas in the presence of seed particles. During the use of a fluidized bed reactor system to manufacture the granulate polycrystalline silicon there are a number of transportation steps where granulate polycrystalline silicon, or seed particles, may be moved from the bed of the fluidized reactor to a point external to the reactor chamber, and particularly in the case of granulate polycrystalline silicon when it is desired to harvest the polycrystalline silicon. At all stages of transportation of granulate polycrystalline silicon, there is a risk of contamination by physical contact with the surfaces of the equipment including notably the metal surfaces of the supporting infrastructure of the FBR system, external to the fluidized bed, thereby leading to metal contamination. Exemplary of supporting infrastructure are the pipelines and transfer conduits through which granulate polycrystalline silicon must pass. Accordingly there is a need to mitigate the opportunity of metal contamination from such auxiliary structure and equipment.

### SUMMARY

According to one aspect, this disclosure concerns a method of reducing or eliminating contamination of particulate silicon from contact of a metal surface, being the inner wall of a metal conduit, the method wherein the inner wall of the metal conduit is at least partially coated with a protective layer, preventing the particulate silicon from contacting the metal, comprising a microcellular elastomeric polyurethane.

According to a further aspect, this disclosure relates to a fluidized bed reactor unit for production of granulate polycrystalline silicon wherein the fluidized bed reactor unit comprises at least one metal pipe or conduit, external to the reactor chamber, and wherein the at least one metal pipe or conduit has an inner surface at least partially coated with a protective coating comprising a microcellular elastomeric polyurethane.

According to a yet further aspect, this disclosure relates to a process for the production of granulate polycrystalline silicon which comprises effecting pyrolysis of a silicon-containing gas using a fluidized bed reactor, and depositing a polycrystalline silicon layer on a seed particle wherein the transportation of the seed particle prior to entry and/or the coated seed particle after exit from the fluidized bed reactor, is via a feed or discharge conduit having an inner surface wall at least partially coated with a protective coating comprising a microcellular elastomeric polyurethane.

### BRIEF DESCRIPTION OF THE DRAWINGS

FIG. 1 is a schematic cross-sectional view of a metal conduit having an inner surface coated with a protective coating.

FIG. 2 is a schematic diagram of a fluidized bed reactor unit having one or more metal conduits having an inner surface coated with a protective coating, and optionally having a polyurethane hose in place of a metal conduit.

### DETAILED DESCRIPTION

Unless otherwise stated, all numbers and ranges presented in this application are approximate—within the scientific uncertainty values for the tests required to determine such number values and ranges, as known to those of ordinary skill in the art.

The expressions “at least partial protective layer” and “coated at least partially” in this context imply that the protective layer need not cover the metal conduit surface completely. Discontinuities in the protective layer may be due to, e.g., cracking caused by stretching or bending of the substrate material; to grain boundaries particularly in a crystalline material; to insufficient cleaning prior to the coating process; impurities or particles on the substrate surface; to physical damage; or to combinations thereof. Sections of the surface may also be left uncoated e.g. for technical reasons relating to the joining of parts.

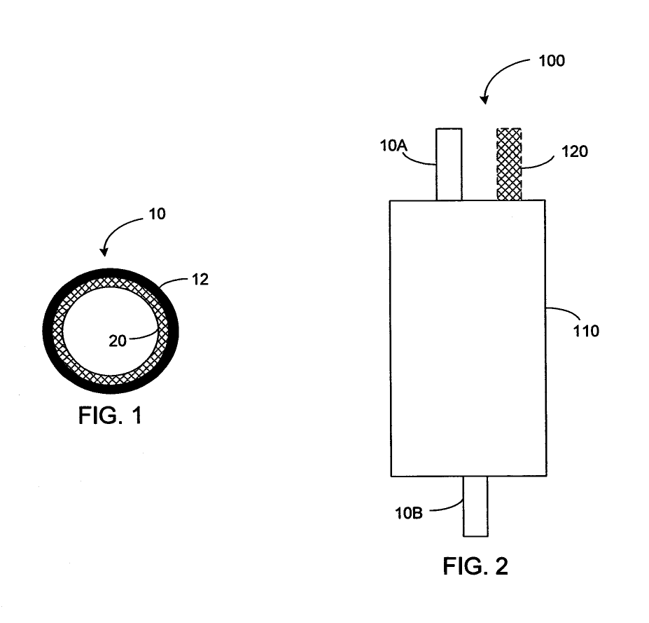

Contact metal contamination is reduced considerably by using at least a partial protective coating as disclosed herein, even if the protective coating includes discontinuities as described above. In some embodiments, at least 50% or at least 75% of the surface is coated by a protective coating as disclosed herein. In certain embodiments, the surface is completely covered by the protective coating. “Completely” should be taken as essentially free from defects from a practical point of view. FIG. 1 illustrates a cross section of metal conduit 10. The inner surface of the conduit wall 12 is at least partially covered with a protective coating 20.

A protective coating may include several layers with different functionality. Typical functional layers include, for example, primer layers, adhesion layers, and barrier layers. Embodiments of the protective coating require, and if comprising multiple layers require that the outermost layer, that will be in contact with the particulate polycrystalline silicon comprise a microcellular elastomeric polyurethane. In some embodiments, the protective coating consists of a microcellular elastomeric polyurethane. By “protective layer coating” it is understood a coating having an overall average thickness of from at least 0.1, such as from at least 0.3, or from at least 0.5 millimetres; and up to a thickness of 10, such up to 7, or up to 6 millimetres. Thus, embodiments of the disclosed protective coatings may have a thickness from 0.1-10 mm, such as 0.3-7 mm or 0.5-6 mm.

The term “elastomeric” refers to a polymer with elastic properties, e.g., similar to vulcanized natural rubber. Thus, elastomeric polymers can be stretched, but retract to approximately their original length when released.

The term “microcellular” generally refers to a foam structure having pore sizes ranging from 1-100 μm. Microcellular materials typically appear solid on casual appearance with no discernible reticulate structure unless viewed under a high-powered microscope. With respect to elastomeric polyurethanes, the term “microcellular” typically is equated to density, such as an elastomeric polyurethane having a bulk density greater than 600 kg/m³. Polyurethane of lower bulk density typically starts to acquire a reticulate form and is generally less suited for use as protective coating described herein.

Microcellular elastomeric polyurethane suitable for use in the disclosed application is that having a bulk density of 1150 kg/m³ or less, and a Shore Hardness of at least 65A. In one embodiment the elastomeric polyurethane has a Shore Hardness of up to 90A, such as up to 85A; and from at least 70A. Thus, the Shore Hardness may range from 65A to 90A, such as 70A to 85A. Additionally, the suitable elastomeric polyurethane will have a bulk density of from at least 600 kg/m³, such as from at least 700 kg/m³, or from at least 800 kg/m³; and up to 1100 kg/m³, such as up to 1050 kg/m³. Hence, the bulk density may range from 600-1150 kg/m³, such as 700-1100 kg/m³ or 800-1050 kg/m³. The bulk density of solid polyurethane is understood to be in the range of 1200-1250 kg/m³. Elastomeric polyurethane can be either a thermoset or a thermoplastic polymer; this presently disclosed application is better suited to the use of thermoset polyurethane. Microcellular elastomeric polyurethane having the above physical attributes is observed to be particularly robust and withstands the abrasive environment and exposure to particulate, granulate, polysilicon eminently better than many other materials previously proposed as protective layers for the same application. Elastomeric polyurethane can be obtained by reaction of a polyisocyanate with a polyether polyol giving a polyether polyol-based polyurethane, or alternatively by reaction of a polyisocyanate with a polyester polyol giving a polyester polyol-based polyurethane. Polyester polyol-based polyurethane elastomers are typically observed as having physical properties better suited to the presently disclosed application compared to the polyether polyol-based polyurethane elastomer and hence are the preferred elastomeric polyurethane for use herein.

In one aspect, as shown in FIG. 2, a modified fluidized bed reactor unit 100 for production of particulate or granulate polycrystalline silicon is disclosed wherein one or more metal conduits, pipes or nozzles 10A, 10 B, external to the reactor chamber 110, have their inner surface at least partially coated with a protective coating comprising a microcellular polyurethane elastomeric material as described hereinabove and illustrated in FIG. 1. Such metal pipes are feed pipelines or discharge pipelines associated respectively with the feed of particulate polysilicon seed to the reactor, or discharge and harvesting of granulate polysilicon from the reactor. The protective layer functions to prevent direct contact of the polycrystalline silicon particle with the metal pipe's inner surface wall and thereby reduces or eliminates metal contamination of the polycrystalline silicon particle. Additional avoidance of metal contact contamination within the fluidized bed reactor unit can be achieved by employing, where structural engineering performance needs and operational conditions permit, polyurethane hoses 120 or hoses where the innermost surface in contact with the granulate polysilicon comprises the microcellular elastomeric polyurethane. In this instance, suitable polyurethane hose includes products such as described in the patent publications including U.S. Pat. No. 5,918,642; U.S. Pat. No. 6,227,249; U.S. Pat. No. 6,192,940 or U.S. Pat. No. 6,024,134.

Polyurethane is susceptible to thermal degradation on exposure to elevated temperatures. For the purpose of this disclosed application, the use of a polyurethane protective coating is best applied to metal surfaces and regions of the fluidized reactor unit where the operational temperature is 200° C. or less, such as 180° C. or less, or 160° C. or less. The onset temperature for thermal degradation of polyurethane can be controlled to a limited extent by the makeup of the polyurethane, but generally temperatures greater than 200° C. will bring about some degree of degradation to the polyurethane polymer.

Procedures for the manufacture of microcellular polyurethane elastomers are well known to a person skilled in the in the art and in general comprises reacting a polyol with a polyisocyanate optionally but desirably in the presence of adjuvants including crosslinking agents, catalysts, and other processing aids. Exemplary publications listed below teaching the preparation of microcellular polyurethane elastomers include U.S. Pat. No. 4,647,596; U.S. Pat. No. 5,968,993; U.S. Pat. No. 5,231,159; U.S. Pat. No. 6,579,952; US2002/111,453 and US2011/003103. Procedures for the manufacture of polyurethane-lined metal pipes and nozzles are also known to a person skilled in the art and exemplified by publications including US2005/189,028; GB 2,030,669; U.S. Pat. No. 5,330,238; or JP52-20452.

The manufacture of a particulate polycrystalline silicon by a chemical vapour deposition method involving pyrolysis of a silicon-containing substance such as for example silane, disilane or halosilanes such as trichlorosilane or tetrachlorosilane in a fluidized bed reactor is well known to a person skilled in the art and exemplified by many publications including those listed below.

| Title | Publication Number |
|---|---|
| Fluidized Bed Reactor for Production of | US2010/0215562 |
| High Purity Silicon | |
| Method and Apparatus for Preparation of | US2010/0068116 |
| Granular Polysilicon | |
| High-Pressure Fluidized Bed Reactor | US2010/0047136 |
| for Preparing Granular Polycrystalline | |
| Silicon | |
| Method for Continual Preparation of | US2010/0044342 |
| Polycrystalline Silicon using a Fluidized | |
| Bed Reactor | |
| Fluidized Bed Reactor Systems and | US2009/0324479 |
| Methods for Reducing The Deposition | |
| Of Silicon On Reactor Walls | |
| Process for the Continuous Production | US2008/0299291 |
| of Polycrystalline High-Purity Silicon | |
| Granules | |
| Method for Preparing Granular Poly- | US2009/0004090 |
| crystalline Silicon Using Fluidized | |
| Bed Reactor | |
| Method and Device for Producing | US2008/0241046 |
| Granulated Polycrystalline Silicon | |
| in a Fluidized Bed Reactor | |
| Silicon production with a Fluidized | US2008/0056979 |
| Bed Reactor integrated into a Siemens- | |
| Type Process | |
| Silicon Spout-Fluidized Bed | US2008/0220166 |
| Method and apparatus for preparing | US2002/0102850 |
| Polysilicon Granules | |
| Method and apparatus for preparing | US2002/0086530 |
| Polysilicon Granules | |
| Machine for production of granular | US2002/0081250 |
| silicon | |
| Radiation-heated fluidized-bed reactor | U.S. Pat. No. 7,029,632 |
| Silicon deposition reactor apparatus | U.S. Pat. No. 5,810,934 |
| Fluidized bed for production of poly- | U.S. Pat. No. 5,139,762 |
| crystalline silicon | |
| Manufacturing high purity/low chlorine | U.S. Pat. No. 5,077,028 |
| content silicon by feeding chlorosilane | |
| into a fluidized bed of silicon particles | |
| Fluid bed process for producing polysilicon | U.S. Pat. No. 4,883,687 |
| Fluidized bed process | U.S. Pat. No. 4,868,013 |
| Polysilicon produced by a fluid bed process | U.S. Pat. No. 4,820,587 |
| Reactor And Process For The Preparation | US 2008/0159942 |
| Of Silicon | |
| Ascending differential silicon harvesting | U.S. Pat. No. 4,416,913 |
| means and method | |
| Fluidized bed silicon deposition from | U.S. Pat. No. 4,314,525 |
| silane | |
| Production of Silicon | U.S. Pat. No. 3,012,861 |
| Silicon Production | U.S. Pat. No. 3,012,862 |

The expression “particulate” or “granulate” refers to polycrystalline silicon that can be seed material brought into the reactor through a feed line or product exiting the reactor via the discharge pipeline and encompasses material having an average size in its largest dimension of from 0.01 micron, to as large as 15 millimeters. More typically, the majority of the particulate polycrystalline silicon in passage through the feed or notably the discharge pipelines will have an average particle size of from 0.1 to 5 millimeters and be essentially spheroid in form and devoid of the presence of any sharp or acute edge structure and thus being an essentially smooth particle.

It is observed that such polyurethane-lined pipes and nozzles are able to satisfactorily mitigate metal contamination of the granulate polysilicon during transportation in the FBR manufacturing operations and are surprisingly robust with minimal failure. Abrasive failure or fractures of the polyurethane lining through the transportation of granulate polysilicon at various conveyance speeds is surprisingly low and absent. Organic or carbon contamination of the polysilicon is also observed to be minimal and not distracting from the overall quality of the polysilicon.

The specific examples included herein are for illustrative purposes only and are not to be considered as limiting to this disclosure.

### EXAMPLE

### Accelerated Abrasion Wear Testing

Accelerated abrasion wear testing of a variety of plastic resins considered as potential candidates for deployment as the protective coating layer in the presently disclosed application has been conducted. The test procedure has been designed to mimic conditions that might occur in a typical FBR operation and the manufacture and transfer of granulate polysilicon.

The general procedure consists of subjecting coupons (3″×3″×0.5″ (7.6 cm×7.6 cm×1.3 cm)) of plastic resins to abrasive impact erosion by particulate polysilicon and observing the change to the surface of the coupon after a given time. The particulate or granular polysilicon used consists of essentially smooth spheroid particles having an average (95%) particle size of from 0.9-1.2 mm. The polysilicon particles are caused to impact the large (3×3) surface of the plastic coupons, at a focused central point, by being carried in a jetted air stream operating at a pressure of about 15 psi (0.1 MPa) and estimated as conferring a particle velocity of from 45 to 55 feet/sec (13.7 to 16.8 m/sec). The orientation of the jetted air stream is set to provide a fixed given impact angle, relative to the coupon surface. This configuration exposes the coupon surface to passage of approximately 24 kg/hour of granular polysilicon material. The wear and abrasive loss on the coupon being observed by formation of a surface crater the depth of which is measured after a set continuous exposure time to polysilicon.

Table 1, below presents the observations; it is clearly seen that elastomeric polyurethanes have superior performance as evidenced by the reduced crater formation.

| | Comparative | | Comparative | | | | | |
|---|---|---|---|---|---|---|---|---|
| | Example 1 | | Example 2 | | Example 1 | | Example 2 | |
| Coupon | Polypropylene | | Ethylene- | | Polyurethane | | Polyurethane | |
| Material | | | tetrafluoroethylene | | Elastomer | | Elastomer | |
| | | | | | (Polyether | | (Polyester polyol- | |
| | | | | | polyol-based) | | based) | |
| Density | 900 | | 1700 | | 1100 | | 1100 | |
| (kg/m³) | | | | | | | | |
| Shore | 67 D | | 67 D | | 80 A | | 74 A | |
| Hardness | | | | | | | | |
| Exposure | 1500 | 1500 | 1500 | 1500 | 1500 | 1500 | 1500 | 1500 |
| Time | | | | | | | | |
| (mins) | | | | | | | | |
| Impact | 15 | 30 | 15 | 30 | 15 | 30 | 15 | 30 |
| Angle | | | | | | | | |
| (Degrees) | | | | | | | | |
| Crater | 0.18″ | Exceeded | Not | 0.4″ | 0.04″ | 0.05″ | <0.01″ | 0.01″ |
| Depth | 4.6 | 0.5″ | Observed | 10 mm | 1 mm | 1.3 mm | <0.3 mm | 0.3 mm |
| (Inches, | mm | 13 mm | | | | | | |
| mm) | | | | | | | | |

Although the subject invention has been described with respect to preferred embodiments, those skilled in the art will readily appreciate that changes or modifications thereto may be made without departing from the spirit or scope of the subject invention as defined by the appended claims. In view of the many possible embodiments to which the principles of the disclosed processes may be applied, it should be recognized that the teachings herein are only preferred examples and should not be taken as limiting the scope of the invention.

We claim:

1. A method of reducing or eliminating contamination of particulate silicon from contact with a metal inner surface of a metal conduit during movement of the particulate silicon through the conduit, the method comprising:
conveying particulate silicon through a metal conduit having an inner surface at least partially coated with a protective layer comprising a microcellular elastomeric polyurethane.

2. The method of claim 1 wherein the microcellular elastomeric polyurethane has a bulk density of 1150 kg/m³ or less and a Shore Hardness of at least 65A.

3. The method of claim 2 wherein the microcellular elastomeric polyurethane has a Shore Hardness of at least 70A and a bulk density of from at least 800 kg/m³.

4. The method of claim 2 wherein the microcellular elastomeric polyurethane has a Shore Hardness of from 65A to 85A and a bulk density of from 800 to 1150 kg/m³.

5. The method of claim 1 wherein the protective layer has a thickness of up to 10 millimetres.

6. The method of claim 5 wherein the thickness is from at least 0.3 millimetres and up to 7 millimetres.

7. A method according to claim 1 wherein the coated metal surface is that of a component associated with a fluidized bed reactor installation, but excluding a fluidized bed reactor chamber of the fluidized bed reactor installation.

8. The method of claim 7 wherein the coated metal surface has an operational temperature of less than 180° C.

9. The method of claim 8 wherein the component associated with the fluidized bed reactor installation is a feed pipeline or nozzle, or a discharge pipeline or nozzle.

10. A fluidized bed reactor unit for production of polycrystalline silicon wherein the fluidized bed reactor unit comprises a reactor chamber and at least one metal pipe or nozzle, external to the reactor chamber, having an inner surface at least partially coated with a protective layer comprising a microcellular elastomeric polyurethane.

11. The fluidized bed reactor unit of claim 10 wherein the microcellular elastomeric polyurethane has a bulk density of 1150 kg/m³ or less and a Shore Hardness of at least 65A.

12. The fluidized bed reactor unit of claim 10 wherein the protective layer has a thickness of up to 10 millimetres.

13. The fluidized bed reactor unit of claim 10 which further comprises at least one section of polyurethane hose.

14. A process for the production of granulate polycrystalline silicon, comprising:
effecting pyrolysis of a silicon-containing gas using a fluidized bed reactor comprising a feed or discharge conduit having a metal inner surface at least partially coated with a protective layer comprising a microcellular elastomeric polyurethane;
depositing a polycrystalline silicon layer on a seed particle in the fluidized bed reactor to produce granulate polycrystalline silicon; and
transporting the seed particle prior to entry, transporting granulate polycrystalline silicon after exit from the fluidized bed reactor, or both via the feed or discharge conduit in which the protective layer prevents contact of the seed particle, the polycrystalline silicon particle, or both with the metal inner surface of the feed or discharge conduit and reduces or eliminates metal contamination of the seed particle, the polycrystalline silicon particle, or both.
